(19) United States
(12) Patent Application Publication
(10) Pub. No.: US 2005/0044021 A1
(43) Pub. Date: Feb. 24, 2005

(54) Method and system of funds transfer

(76) Inventor: Richard W. Schafer, Huntington Beach, CA (US)

Correspondence Address: CISLO & THOMAS, LLP, 233 WILSHIRE BLVD, SUITE 900, SANTA MONICA, CA, 90401-1211, US

(21) Appl. No.: 10/646,564

(22) Filed: Aug. 22, 2003

(51) Int. Cl. G06F 17/60

(52) U.S. Cl. 705/35; 705/42

(57) ABSTRACT

Exemplary embodiments disclosed herein are directed to methods and systems for transferring funds, including establishing an account via a client coupled to a computer network, depositing funds into the account, and withdrawing funds from the account, wherein the account is a modified unsecured account established via the client coupled to a public accessible global computer network.

### BACKGROUND

Current funds transfer systems may have many limitations and drawbacks including providing a significant amount of information to establish an account, securing the account with a credit card, and having to travel to the account setup location.

It would be advantageous to have a system to overcome these limitations and drawbacks. What is needed is a system by which a payor may quickly and easily establish and fund an account, such that a payee may access the account and funds from a remote location. Such systems, for example, may be ideal for parents to provide their children in college with funds to cover their living expenses and costs and fees incurred in attending college far from home, and the like.

### SUMMARY

Exemplary embodiments disclosed herein are directed to methods and systems for transferring funds, including establishing an account via a client coupled to a computer network, depositing funds into the account, and withdrawing funds from the account, wherein the account is a modified unsecured account established via the client coupled to a public accessible global computer network.

### BRIEF DESCRIPTION OF THE DRAWINGS

FIG. 1 is a block diagram of an exemplary embodiment of a method for transferring funds.

FIG. 2 is a block diagram of an exemplary embodiment of a method for establishing a modified unsecured account.

FIG. 3 is an exemplary embodiment of a system for transferring funds.

### DETAILED DESCRIPTION

The detailed description set forth below in connection with the appended drawings is intended as a description of exemplary embodiments and is not intended to represent the only forms in which the embodiments may be constructed and/or utilized. The description also sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

For many years parents may have provided money to their children attending college by utilizing joint checking accounts in which a parent deposits money in one branch of a bank and the son or daughter withdraws money from a different branch. However, such a system may be fraught with problems. Young students may often abuse a checking account by overdrawing funds. The parents may then be placed in the position of having to replenish funds in the checking account on very short notice. Moreover, expensive overdraft charges may be incurred. Even if checks are written responsibly, there may be a significant coordination problem between the parent and student to maintain an adequate balance in the account.

Exemplary embodiments disclosed herein may provide a method and system for expeditiously transferring money from one individual to another, which may not require either the payor or payee to have immediate access to a bank account, or even to have a bank account at all. Exemplary embodiments may allow an individual recipient to telephone or e-mail or otherwise contact a payor so that the payor may promptly and easily arrange for money to be transferred to a newly-established debit account, or a debit account that is set up to utilize an automatic teller machine (ATM) system and through the software of a financial institution and over the Internet. The payor may utilize the Internet or other network to access his or her bank, and may then choose an option to arrange for transfer of funds to the payee. The software of the system may supply a personal identification number (PIN)/account code and a password to give a payee to allow access of the account at an ATM, or other location, to access the money. The account may require verification for a one-time use of transferring and debiting money only, and may include verification that the funds have been withdrawn. Money may then be debited from the payor's account.

Exemplary embodiments may utilize the Internet to meet the demands of individuals needing money, not only for emergencies, but also for parents sending money to their college students for their personal expenses, for their dormitory meal cards, and the like. Exemplary embodiments may also be useful for dedicated workers who wish to send money to family members located in a different country. Exemplary embodiments may be utilized to transfer funds from the currency of the country in which the payor is located to a different country employing a different currency in which the payee is located.

Exemplary embodiments of a system and method for transferring funds and establishing a modified unsecured account may lend themselves to use through a wide variety of partners, such as, but not limited to, retail establishments, and the like. The opportunity for electronic funds transfer may be extremely flexible in this regard. Member merchants at merchant locations may provide the payee with funds authorized for withdrawal through a central accounting entity with which the payee has established a new account, or has an existing account.

The exemplary embodiments of the funds transfer system may greatly reduce the many steps and considerable effort required on both the part of the payor and payee to transfer funds. According to one exemplary embodiment, the payor may initiate the transfer through his/her own personal computer and may never need to go to a bank or any other location during any step in the process. The payee may retrieve the funds from a wide variety of establishments, including ATMs, member merchant locations, university cafeterias and other locations that are quite convenient to the payee.

Exemplary embodiments may provide a simple and easy way for a payor to replenish debit cards, and to make direct deposits onto college meal and campus cards for a minimal transaction fee. Exemplary embodiments may also provide a swift and easy method for transferring funds to deal with medical emergencies, vehicle breakdowns and other situations in which money is required rapidly. Exemplary embodiments may be highly useful for individuals who do not have convenient access to bank accounts, individuals who do not even have a bank account, and individuals in need of money beyond the resources of their accounts, such as for emergency situations, and the like.

Exemplary embodiments also may be advantageous for banking establishments because they may provide a new online service to customers that may be convenient, secure and quick. Exemplary embodiments may provide a method for efficient and uncomplicated personal funds transfers. Benefits to bank customers may include enhanced flexibility and a new avenue of access to money. Moreover, the system may allow individuals without a bank account to access funds via a PIN code rather than a debit card.

Exemplary embodiments may also provide a suitable method for payroll departments or payroll services with software to set up PIN codes for company employees who do not have bank accounts. Exemplary embodiments may be particularly useful to companies that employ individuals who are paid on an hourly basis. It may offer the benefit of having a direct deposit program in a PIN/account code or debit card set up for individuals, without need for the individual to establish and maintain a formal bank account.

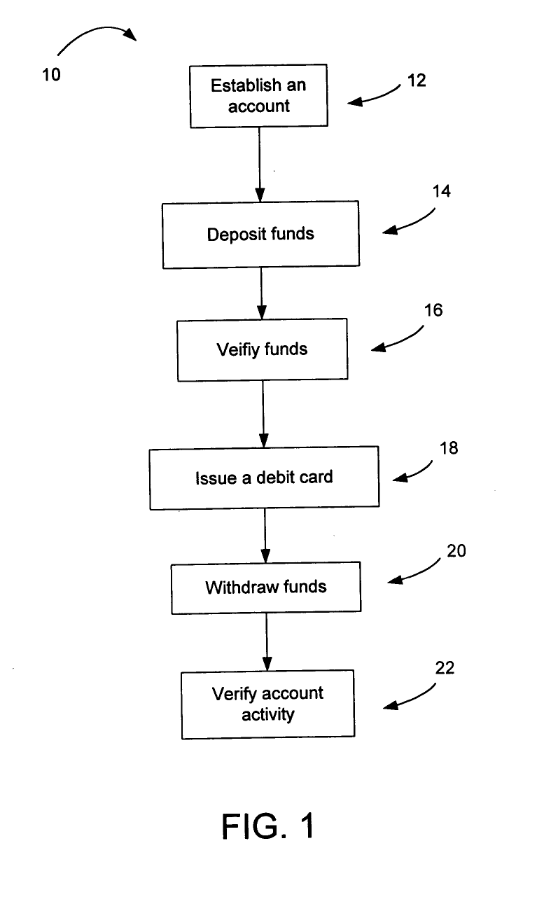

A funds transfer method according to the present invention is shown in FIG. 1, generally at 10. System 10 typically includes establishing an account at 12, depositing funds at 14, and verifying funds at 16. Optionally, the system 10 may include issuing a debit card at 18. Withdrawing funds is shown at 20 and verifying the withdrawal of funds is shown at 22.

According to one exemplary method, establishing an account at 12 may be accomplished by a payor at virtually any computer connected to the Internet. In this manner, a payor may almost instantaneously establish an account online that would allow them to almost instantaneously deposit funds into that account for use shortly thereafter. Alternatively, in another exemplary method, establishing an account may occur when a payor goes into a member merchant and the member merchant sets up the account for the payor in a similar manner, via an Internet connection.

Depositing funds at 14 may be accomplished with cash, direct check, debit card, credit card, or other method of supplying funds, as desired. For example, if the payor wishes to deposit funds into the account with cash, the payor may go into a member merchant location and give the member merchant the cash, and the member merchant may then enter the amount into the system.

If the payor wants to deposit funds into the account with a direct check or personal check, a similar method may be used wherein the payor visits a member merchant location to deposit the funds.

If a payor wishes to use a debit card to deposit funds into the account, the payor may do this online from his or her own home or any other computer connected to the Internet. Similarly, if a payor wants to deposit funds into the account via a transfer from a credit card, they may enter the information on a secure link online to deposit funds into the account. In this manner, the account may be setup and funded almost instantaneously, without the payor having to fill out burdensome paperwork or subject themselves to credit checks or identity checks. Similarly, a payor may transfer funds into the newly created account from another account, such as a bank or brokerage account.

At 16, the funds are verified. This may occur when the payor physically goes into a member merchant location if the funding is to be accomplished with cash or a personal check. This verification may take place online if the payor wishes to use a debit card or credit card to deposit money into the account via known credit and debit account verification methods.

Optionally at 18, a debit card may be issued to allow access to the account. Alternatively, a payee may travel to a member merchant location to receive cash. Therefore, a payee may access the account via a one-time debit card, a multi-use rechargeable debit card, pre-established credit card, or may physically go to a member merchant location to receive the funds. In this manner, a payee may not have to physically go to a member merchant location to receive or to access the account. The payee may only have to utilize an ATM or may access the account at any location that would accept a debit or credit card. In this manner, funds may be transferred quickly, easily, and without either the payee or payor having to physically travel to a bank or money wiring service which may not be open at the time the funds are needed. Furthermore, the payor and payee may not have to subject themselves to credit checks, identity checks, and the like, such that this system and method may be more attractive to potential customers.

Next, at 20 is the withdrawal of funds from the account. This again may be accomplished as described above, either via an ATM machine, in a member merchant location, a location where a debit or credit card may be used, or by transferring the funds to another account.

Optionally, verifying withdrawal of funds may be accomplished, at 22. This may optionally occur to let the payor know that the payee has withdrawn all of the funds, some of the funds, or any account activity that has taken place. This may allow a parent payor to monitor the account and spending habits of a student or child payee, as desired. According to one exemplary embodiment, the payor has access to the account and account activity, and the payee does not. In this manner, the payee would not have to have any identification or credit information supplied, as they would only have access to the account to withdraw funds. It will be appreciated that other arrangements and configurations may be utilized, as desired.

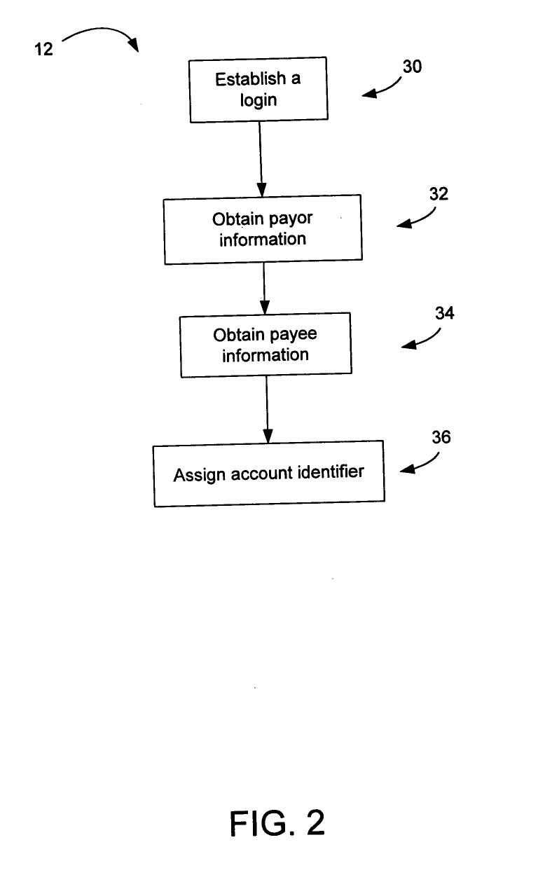

Turning now to FIG. 2 is a method of establishing an account, generally at 12. Establishing account 12 may include establishing a login at 30, obtaining payor information at 32, obtaining payee information at 34, and assigning an account identifier at 36.

Establishing a login at 30 may include entering an e-mail address and a password on a secured site such as are typically used on many websites. At 32, payor information is obtained, which may include an e-mail address and other information, but would typically not include securing the account with a credit card, the social security number of the payor, or other information that may be used to check the credit history, or any other method of securing the account.

At 34, payee information may be obtained. This information may include an e-mail address, a name, and identification number of some kind, such that the payee may be identified if the payee has to go into a member merchant location to access the account and funds. However, if a one-time use debit card is made, the payee information may be minimal. The debit card may need to be mailed to some address, therefore an address may need to be known. However, if a one-time use debit card is to be picked up at a member merchant location, only a name may be required with the member merchant verifying the identity of the recipient of the card via a driver's license or other identification. In this manner, the payor and payee need not have a bank account, credit card, or other account to transfer funds. At 36, an account identifier is assigned such that the payor and payee may continue to use the account and access the account, as needed.

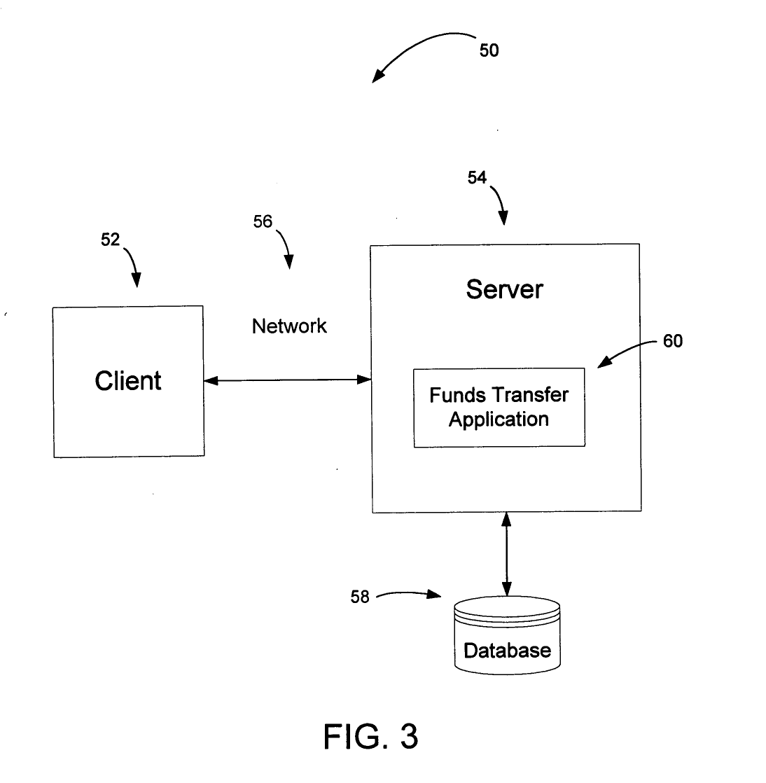

FIG. 3 is a system according to an exemplary embodiment, generally at 50. System 50 typically includes a client 52 coupled to a server 54 via a network 56. System 50 may also include a funds transfer application 60 that typically resides on server 54. Funds transfer application 60 may be configured to execute instructions that operate the overall system. Funds transfer application 60 may also reside in other locations that allow a client to access and utilize it. According to one exemplary embodiment, the system 50 may also include a database 58 coupled to server 54 to store information utilized by the server 54 and the system 50.

Client 52 may be a terminal, computer, personal digital assistant (PDA), cellular telephone, blackberry-type device, or other device that is configured to couple to a network 56. In this manner, a payor may utilize a client 52 to establish an account, fund an account, and transfer funds from any device that may have access to the Internet. In this manner, a payor may setup an account and access an account from any device connected to the Internet.

Server 54 is typically a web-hosting server that contains programming and software that operate the overall system, including funds transfer method 10. Network 56 may be a local area network (LAN), wide area network (WAN), virtual network, wireless network, a public accessible global computer network, such as the Internet, and the like, such that client and server are coupled to a network and are able to transfer data between them.

System 50 may optionally include a database 58 that is coupled to server 54 to store account information such as, but not limited to, account identifiers, funds available, debit and credit cards that are allowed to access the account, and the like. It will be appreciated that although a client server and network configuration are shown in FIG. 3, many other configurations may be utilized to accomplish the functions of the system, as desired.

With this configuration, a payor may setup an account at any time of day from their own home and fund the account such that a payee may have relatively instantaneous access to transferred funds. Alternatively, this system may be utilized to send money to foreign countries on a pre-established debit card, or other methods.

In this manner, a modified unsecured account may be established. The modified unsecured account may be secured by direct funds, but does not need to be secured by credit information such as, but not limited to, a credit card, credit history, social security number, and the like. This may make it more attractive and easy for users to transfer money, and may cause them to utilize this system rather than other current methods of transferring funds.

In contrast, to open an account at a bank or credit union, information regarding credit history and employment, as well as date of birth may be required. To acquire a credit card, extensive credit information, date of birth and bank account information may be required.

Current unsecured accounts may include accounts such as a personal credit card account that is not secured by direct funds, but may be secured by credit information, such as, but not limited to, credit history, employer information, and the like.

In closing, it is to be understood that the exemplary embodiments described herein are illustrative of the principles of the present invention. Other modifications that may be employed are within the scope of the invention. Thus, by way of example, but not of limitation, alternative configurations may be utilized in accordance with the teachings herein. Accordingly, the drawings and description are illustrative and not meant to be a limitation thereof.

1. A method for transferring funds, comprising:
establishing an account via a client coupled to a global network;
depositing funds into said account; and
withdrawing funds from said account;
wherein said account is secured by said deposited funds, but unsecured by credit information.

2. The method of claim 1, further comprising issuing a debit card corresponding to said account.

3. The method of claim 1, further comprising verifying said deposited funds.

4. The method of claim 1, further comprising verifying said withdrawing of said funds.

5. The method of claim 1, wherein said establishing an account comprises:
establishing a login; and
entering payor information; and
providing payee information.

6. The method of claim 5, wherein said entering said payor information does not include the payor's social security number.

7. The method of claim 5, wherein said providing said payor information does not include a credit card number of said payor.

8. The method of claim 5, wherein said providing said payee information does not include the payee's social security number.

9. The method of claim 1, wherein said client is a personal computer.

10. The method of claim 9, wherein establishing an account is accomplished remotely by a payor.

11. The method of claim 1, wherein said establishing an account is accomplished at any client connected to a public accessible global computer network.

12. The method of claim 1, wherein said establishing an account is accomplished by a payor or a member merchant.

13. The method of claim 1, wherein said depositing funds is depositing currency, depositing via personal check, depositing funds from a debit card, depositing funds from a credit card, or transferring funds from another account.

14. The method of claim 1, wherein said withdrawing funds is withdrawing funds by utilizing a debit card, utilizing an identification card, utilizing a pre-established credit card, transferring funds to another account, or obtaining currency from a member merchant.

15. The method of claim 1, wherein credit information is social security number, driver's license number, credit card number, date of birth, employer information, or bank account number.

16. A method for transferring funds, comprising:
establishing an account;
depositing funds into said account;
receiving a prepaid debit card encoded with information corresponding to said account; and
withdrawing funds from said account utilizing said debit card;
wherein said account is secured by said deposited funds but unsecured by credit information, and is remotely established via a client coupled to a public accessible global computer network.

17. The method of claim 16, wherein said withdrawing funds includes obtaining currency from an automated teller machine.

18. The method of claim 16, wherein said account information comprises an account identifier, personal identification number, and amount of funds available.

19. The method of claim 16, wherein said depositing funds is depositing currency, depositing via personal check, depositing funds from a debit card, depositing funds from a credit card, or transferring funds from another account.

20. The method of claim 16, wherein establishing an account comprises:
establishing a login;
entering payor information; and
providing payee information.

21. The method of claim 16, wherein credit information is social security number, driver's license number, credit card number, date of birth, employer information, or bank account number.

22. A method for establishing a modified unsecured account, comprising:
entering payor information;
providing payee information; and
assigning an account identifier and password for said modified unsecured account;
wherein said modified unsecured account is unsecured by credit information;
wherein said account can be established utilizing any client connected to a public accessible global computer network.

23. The method of claim 22, further comprising depositing funds corresponding to said modified unsecured account.

24. The method of claim 22, further comprising issuing a debit card corresponding to said modified unsecured account.

25. The method of claim 22, wherein credit information is social security number, driver's license number, credit card number, date of birth, employer information, or bank account number.

26. A system for transferring money, comprising
a network;
a client coupled to said network;
a server coupled to said network; and
a funds transfer application on said server;
wherein an unsecured account is established on said server utilizing said funds transfer application, and via said client;
wherein said unsecured account is secured by deposited funds.

27. The system of claim 26, further comprising a database coupled to said server, configured to store information utilized by said funds transfer application.

28. The system of claim 26, wherein said client is a terminal, a computer, a personal digital assistant, cellular telephone, or a blackberry-type device.

29. The system of claim 26, wherein said server is a computer.

30. The system of claim 26, wherein said client and said server communicate via HTTP protocol.

31. The system of claim 26, wherein said network is a WAN, LAN, a public accessible global computer network, a wireless network, and a virtual wireless network.

32. Computer readable media having instructions stored thereon, which when executed by a computing device, cause the computing device to perform a method comprising the steps of:
establishing an account via a client coupled to a global network;
depositing funds into said account; and
withdrawing funds from said account;
wherein said account is secured by said deposited funds, but unsecured by credit information.

33. A method of transferring funds, comprising:
remotely establishing an unsecured account having an account identifier and password, via a client coupled to a public accessible global computer network; and
remotely funding said unsecured account by depositing money via a client coupled to a public accessible global computer network and thereby providing security up to the amount of money deposited in said unsecured account;
withdrawing funds from said unsecured account from a remote location up to the amount deposited into said unsecured account by providing said account identifier and said password, wherein those funds requested are released to a person presenting said account identifier and password.

34. The method of claim 33, wherein remotely funding said unsecured account comprises transferring funds from another account to said unsecured account.

35. The method of claim 33, wherein said unsecured account is not secured by credit information.

36. The method of claim 33, wherein said credit information is social security number, driver's license number, credit card number, date of birth, employer information, or bank account number.
